(19) United States
(12) Patent Application Publication
(10) Pub. No.: US 2006/0246938 A1
(43) Pub. Date: Nov. 2, 2006

(54) Power control in a communication network

(75) Inventors: Jari Hulkkonen, Oulu (FI); Kari Niemela, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/221,977

(22) Filed: Sep. 9, 2005

(30) Foreign Application Priority Data
May 2, 2005 (EP) 05009628.8

(51) Int. Cl. H04B 7/00; H04Q 7/20; H04B 1/00

(52) U.S. Cl. 455/522; 455/69; 455/70

(57) ABSTRACT

A method of controlling a transmission power for a communication connection in a communication network is provided. The communication network comprises a user equipment communicating with the communication network, at least one transceiver station for providing a connection with the user equipment, wherein a serving transceiver station is provided for the user equipment, and a controller for controlling the at least one transceiver station. A connection value used at the communication connection between the user equipment and the serving transceiver station is determined, and on the basis of the determined connection value, power control parameters are adjusted wherein at least one change of power control parameters is possible between respective connection value ranges. A power control of the transmission power for the communication connection is executed on the basis of a comparison between the adjusted power control parameters and connection quality measurement results determined for the communication connection. Furthermore, a corresponding system and a corresponding controller are provided.

### BACKGROUND OF THE INVENTION

1. Field of the Invention

The present invention relates to a mechanism for executing a power control for adjusting a transmission power for a communication connection in a communication network. In particular, the present invention relates to a method and system for controlling a transmission power for a communication connected between a user equipment and a transceiver station, such as a base station of a communication network, and a corresponding controller in the communication network.

For the purpose of the present invention to be described herein below, it should be noted that

a network element acting as a communication device may for example be any device by means of which a user may access a communication network; this implies mobile as well as non-mobile devices and networks, independent of the technology platform on which they are based; only as an example, it is noted that network elements operated according to principles standardized by the 3^{rd} Generation Partnership Project 3GPP and known for example as UMTS elements are particularly suitable for being used in connection with the present invention, but also network elements working according to a different standard, such as GSM (Global System for Mobile communications) can apply the present invention;

a network element can act as a client entity or as a server entity in terms of the present invention, or may even have both functionalities integrated therein;

a content of communications via a traffic channel may comprise at least one of audio data, video data, image data, text data, and meta data descriptive of attributes of the audio, video, image and/or text data, any combination thereof or even, alternatively or additionally, other data such as, as a further example, program code of an application program to be accessed/downloaded;

method steps likely to be implemented as software code portions and being run using a processor at one of the server/client entities are software code independent and can be specified using any known or future developed programming language;

method steps and/or devices likely to be implemented as hardware components at one of the server/ client entities are hardware independent and can be implemented using any known or future developed hardware technology or any hybrids of these, such as MOS, CMOS, BiCMOS, ECL, TTL, etc, using for example ASIC components or DSP components, as an example;

generally, any method step is suitable to be implemented as software or by hardware without changing the idea of the present invention;

devices or network elements can be implemented as individual devices, but this does not exclude that they are implemented in a distributed fashion throughout the system, as long as the functionality of the device is preserved.

2. Related Prior Art

In the recent years, an increasing expansion of communication networks, e.g. of wire based communication networks, such as the Integrated Services Digital Network (ISDN), or wireless communication networks, such as the cdma2000 (code division multiple access) system, cellular 3^{rd} generation communication networks like the Universal Mobile Telecommunications System (UMTS), the General Packet Radio System (GPRS), or other wireless communication system, such as the Wireless Local Area Network (WLAN), took place all over the world. Various organizations, such as the 3^{rd} Generation Partnership Project (3GPP), the International Telecommunication Union (ITU), 3^{rd} Generation Partnership Project 2 (3GPP2), Internet Engineering Task Force (IETF), and the like are working on standards for telecommunication networks and multiple access environments.

In general, the system structure of a communication network is such that one party, e.g. a subscriber's user equipment, such as a mobile station, a mobile phone, a fixed phone, a personal computer (PC), a laptop, a personal digital assistant (PDA) or the like, is connected via transceivers and interfaces, such as an air interface or the like, to an access network subsystem. The access network subsystem controls the communication connection to and from the user equipment and is connected via an interface to a corresponding core or backbone network subsystem. The core (or backbone) network subsystem switches the data transmitted via the communication connection to a destination party, such as another user equipment, a service provider (server/proxy), or another communication network. It is to be noted that the core network subsystem may be connected to a plurality of access network subsystems. Depending on the used communication network, the actual network structure may vary, as known for those skilled in the art and defined in respective specifications, for example, for UMTS, GSM and the like.

Generally, for properly establishing and handling a communication connection between network elements such as the user equipment and another user terminal, a database, a server, etc., one or more intermediate network elements such as control network elements, support nodes or service nodes are involved.

In case of a wireless communication network, such as a radio communication network based on an UMTS, GSM or EDGE (Enhanced Data rate for GSM Evolution) system, power control (PC) is employed to regulate the transmission (Tx) power of user equipments or mobile stations and transceiver stations such as base stations of the network, i.e. in the uplink and downlink direction of the communication connection. For example, in GSM system PC adjusts Tx power on the basis of connection quality measurements such as RXQUAL and RXLEV measurements. RXQUAL is a logarithmic measure of the bit error rate (BER) at the receiver's side quantized, for example, in 8 levels. RXLEV is a signal strength measure at the receiver's side, which is quantized, for example, in 64 levels. Both parameters are measured by the user equipment and by the network transceiver stations, such as a base transceiver station, in order to determine, amongst others, the signal quality and the influence of neighbouring base stations to the communication connection to a serving base station. In addition, it is possible to measure other signal quality measures such as mean and variance of Bit Error Probability or directly a Frame Error ratio (FER). Generally, PC is relatively slow, i.e. it has a period of 480 ms for normal PC or 120 ms for an Enhanced Power Control (EPC). Thus, it is not able to adapt to rapid changes in received signal quality due to fast fading, but it keeps power high enough so that signal quality remains in an acceptable level.

In order to enhance the data transmission capability of wireless communication networks, for example the voice capacity in GSM and UMTS networks, several improved transmission mechanisms and techniques have been proposed. One of these mechanisms is the so-called adaptive multi-rate (AMR) codec or speech service. AMR provides variable bit rates or modes for speech transmission wherein with an increasing bit error rate a part of the available bit rate is used for error control. The AMR mode adaptation is faster than power control, but it is also not sufficiently fast to adapt to signal changes which are caused, for example, by fast fading.

In existing communication systems, AMR codec mode adaptation (CMA) and PC may work simultaneously to improve, for example, speech performance. As known by those skilled in the art and mentioned above, PC in GSM systems usually works in 480 ms intervals (EPC in 120 ms intervals) and CMA works in 40 ms intervals. The general idea is that PC defines average longer term signal quality while AMR CMA adapts to faster changes in the received signal quality.

By introducing the AMR speech service, communication system performance, for example of the GSM system, is significantly improved in view of voice quality and speech capacity. However, there are some problems.

The AMR capacity may be limited by control channel performance for the most robust full-rate AMR codecs. Interfering cells of neighbouring base stations of a user equipment may cause interference to control channel transmissions of a serving base station to the user equipment. For example, if a user equipment is not receiving a slow associated control channel (SACCH) correctly due to interference, it may drop a call due to Radio Link Timeout (RLT) mechanism. A call may be dropped even if AMR frame error rate (FER) is close to 0, i.e. speech quality is very good. For example, the AMR capacity is limited by downlink SACCH performance. Thus, the AMR capacity gains cannot be obtained in real networks without solving the downlink SACCH performance issues.

Measurements in AMR traffic GSM networks indicates that SACCH Radio Link Timeout may limit the network capacity (especially in DL). In unsynchronized networks (and also in synchronized networks when frame timing offset between cells is used) AMR speech channels interferes SACCH (and vice versa) so that when more AMR traffic is allocated to the system more interference SACCH receives.

In other words, one severe problem is that robust AMR modes provide a better link performance in comparison to SACCH so that the network capacity is limited by SACCH RLT, while calls may be dropped even though the voice quality is still in an acceptable level. Traffic channels and SACCH interfere each other so that when network load increases also SACCH suffers from the increased interference. Furthermore, cellular communication systems, like GSM systems, may use a relatively slow power control. This means that conservatively selected thresholds for power control parameters have to be used in order to make sure that the transmission power is not reduced unduly. Therefore, it is often the situation that the transmission power is increased to the maximum level. However, from the interference point of view, connections transmitting maximal (or close to maximal) power are the worst interfering connections and are causing most of the network interference.

In GSM systems, for example, in case power control parameter thresholds set on a level optimal for most robust AMR modes, such as high PC RXQUAL thresholds (like RXQUAL 5-7) are used, high bit-rate AMR modes may suffer from a high FER and codec mode adaptation (CMA) changes all connections to the robust codecs. This significantly reduces voice quality. On the other hand, when AMR RXQUAL thresholds are optimized according to least robust AMR mode, CMA keeps high bit-rate coded. By means of this, a low FER can be achieved and the best voice quality can be achieved. However, even though these PC settings may optimize the speech quality, higher Tx powers are used which in turn decreases the system capacity since the interference level in the system increases, and also SACCH RLT may then limit the system performance.

The way which is currently used in the existing networks is to select power control parameters, like respective thresholds for connection or signal quality measurements such as RXQUAL thresholds for AMR channel in such a way that some sort of trade-off between voice quality and system capacity is made. FIGS. 9a and 9b show diagrams for illustrating the effect of different PC parameters (i.e. of different threshold settings) on the voice quality and the drop call rate (DCR). In detail, in FIG. 9a, a percentage value of good quality connections for different threshold values is shown. A good quality connection means in the present example a connection where the traffic channel FER is smaller than 1%. In FIG. 9b, the drop call rate based on the SACCH RLT for the same threshold values as in FIG. 9a is shown. It is to be noted that the scale of the respective axes and hence the levels reached by the bars in FIGS. 9a and 9b are only for illustration. Actual levels or values may be different to those shown in these figures. The settings for thresholds, i.e. threshold values e/f, c/d and g/h are increased from left to right. Only as an explanatory example, when RXQUAL thresholds are used as power control parameters, values like low 3 and high 4 for e/f, low 4 and high 5 for c/d, and low 5 and high 6 for g/h can be used, for example. As can be seen from these FIGS. 9a and 9b, thresholds g/h are able to provide a good DCR but the voice quality is rather poor. On the other hand, the smaller thresholds e/f may result in a good voice quality but the DCR is rather high. Hence, a trade-off between voice quality and system capacity is made by choosing the intermediate threshold values c/d, such as RXQUAL thresholds of low 4 and high 5, as power control parameters. However, with such a trade-off, optimal performance is not achieved.

In document US-A-10/867 167 filed by the applicant of the present invention there is described a method to improve SACCH performance by interfering signal PC. According to this method, first connections are evaluated that interfere certain cell SACCH burst wherein a network synchronization is required. Then the Tx power of those bursts is suppressed that interfere the SACCH. In other words, there is made a trade-off between AMR quality and SACCH performance in the downlink direction.

### SUMMARY OF THE INVENTION

It is an object of the invention to provide an improved power control mechanism usable in a communication connection.

In particular, it is an object of the invention to provide a method, a corresponding system and a controller which enable a power control where a good voice quality for a served connection is achieved while the interference level in the network is decreased.

This object is achieved by the measures defined in the attached claims.

In particular, according to one aspect of the proposed solution, there is provided, for example, a method of controlling a transmission power for a communication connection in a communication network, the communication network comprising a user equipment communicating with the communication network, at least one transceiver station for providing a connection with the user equipment, wherein a serving transceiver station is provided for the user equipment, and a controller for controlling the at least one transceiver station, the method comprising steps of determining a connection value used at the communication connection between the user equipment and the serving transceiver station, adjusting power control parameters on the basis of the determined connection value, and executing a power control of the transmission power for the communication connection on the basis of a comparison between the adjusted power control parameters and connection quality measurement results determined for the communication connection.

Furthermore, according to one aspect of the proposed solution, there is provided, for example, a system for controlling a transmission power for a communication connection of a user equipment communicating in a communication network, the system comprising at least one transceiver station for providing a connection with the user equipment, wherein a serving transceiver station is provided for the user equipment, and a controller for controlling the at least one transceiver station, wherein the system is operably connected and configured to determine a connection value used at the communication connection between the user equipment and the serving transceiver station, to adjust power control parameters on the basis of the determined connection value, and to execute a power control of the transmission power for the communication connection on the basis of a comparison between the adjusted power control parameters and connection quality measurement results determined for the communication connection.

Moreover, according to one aspect of the proposed solution, there is provided, for example, a controller for controlling a transmission power for a communication connection of a user equipment communicating in a communication network, the communication network comprising at least one transceiver station for providing a connection with the user equipment, wherein a serving transceiver station is provided for the user equipment, wherein the controller is configured to control the at least one transceiver station and is further operably connected and configured to determine a connection value used at the communication connection between the user equipment and the serving transceiver station, to adjust power control parameters on the basis of the determined connection value, and to execute a power control of the transmission power for the communication connection on the basis of a comparison between the adjusted power control parameters and connection quality measurement results determined for the communication connection.

According to further refinements, the proposed solution may comprise one or more of the following features:

in the adjustment of the power control parameters, there may be at least one change of power control parameters between respective connection value ranges;

a connection value may comprise a transmission power level of the communication connection, preferably a transmission power of at least one of the user equipment and the serving transceiver station; furthermore, a connection value may comprise a result of a network quality measurement result, or a determination of a distance between the user equipment and the transceiver station; furthermore, a connection value may be determined by determining at least-one of a received signal level from the user equipment to the transceiver station and a received signal level from the transceiver station to the user equipment;

the power control parameters may comprise a threshold value of a connection quality measurement, in particular of a bit error rate measurement and/or a frame error rate measurement;

the adjustment of the power control parameters may further comprise a setting of a changing step size for changing the transmission power;

the adjustment of the power control parameters may comprise an increasing the power control parameters when the determined connection value is high; in addition, the adjustment of the power control parameters may comprise an increasing of the changing step size of the transmission power when the determined connection value is low;

the execution of the power control of the transmission power for the communication connection on the basis of the adjusted power control parameters may be performed for a traffic channel of the communication connection; furthermore, the transmission power for a control channel may be set to a higher value than the transmission power used for the traffic channel;

for the traffic channel, an adaptive multi-rate speech service may be used, wherein a codec mode adaptation may be executed for the adaptive multi-rate speech service;

the execution of the power control of the transmission power for the communication connection on the basis of the adjusted power control parameters may be performed in an uplink direction and in a downlink direction;

the communication network may be a circuit switched and/or packet switched radio communication network, the user equipment may be a mobile user terminal, the transceiver station may be a base station (or node B) of the radio communication network and the controller may be comprised in a base station controller and/or a radio network controller of the radio communication network; alternatively, the controller may be comprised in a transceiver station, such as the base station or the node B.

By virtue of the proposed solutions, the following advantages can be achieved:

The present invention provides a power control mechanism by means of which both capacity of a network (which can be increased in heavily loaded network) and speech quality of a connection (which can be improved in a lightly loaded network) are optimized. In other words, the present invention achieves an improved balance between two types of channels (control and traffic channels) so that the total performance of the system is enhanced.

In particular, the present invention is offers specific benefits when a special kind of traffic channel transmission is used, such as AMR. It is possible to reduce the traffic channel transmission power so that the SACCH receives less interference. In other words, the AMR PC is optimized for AMR itself so that both an AMR capacity is improved and SACCH RLT performance is enhanced. This means that the AMR voice quality and capacity can be improved in comparison to the conventional PC methods while also the SACCH performance is enhanced. Furthermore, different AMR modes can be used more efficiently, and the performance difference between SACCH and AMR can be balanced.

The present invention is generally usable in uplink and downlink directions, i.e. for controlling the output power for a user equipment and for a transceiver station of the network.

By adjusting not only power changing points but also a step size for power changing on the basis of the used connection value such as the actual transmission power, it is possible to flexibly control different kinds of connections. For example, connections being subjected to a great change in the connection quality can be handled differently and thus more suitable than connection where the change in the connection quality is low.

Moreover, the present invention is simple to implement and it is compatible with current standards, such as GSM standards. This means that also existing networks can be adapted to the present invention without severe problems. It is also not necessary to change setting in the mobile terminals which makes the implementation of the present invention rather easy.

The above and still further objects, features and advantages of the invention will become more apparent upon referring to the description and the accompanying drawings.

### BRIEF DESCRIPTION OF THE DRAWINGS

FIG. 1 illustrates a simplified arrangement of a communication network in which the present invention is applicable.

FIG. 2 illustrates a part of the communication network of FIG. 1 in greater detail.

FIG. 3 illustrates a flow chart describing a power control method according to an embodiment of the present invention.

FIG. 4 illustrates a table showing a power control parameter setting according to a conventional example and according to one embodiment of the present invention.

FIG. 5 illustrates an example of results for different connection parameters achievable by an embodiment of the present invention.

FIGS. 6 and 7 illustrate diagrams showing a comparison of voice quality results and drop call rates according to a conventional example and an embodiment of the present invention.

FIG. 8 illustrates a diagram showing a comparison of transmission powers used according to a conventional example and an embodiment of the present invention.

FIGS. 9a and 9b illustrate diagrams showing voice quality results and drop call rates according to a conventional example.

FIG. 10 illustrates an example of results for different connection parameters achievable by a conventional example.

### DESCRIPTION OF PREFERRED EMBODIMENTS

In the following, an embodiment of the present invention is described with reference to the drawings.

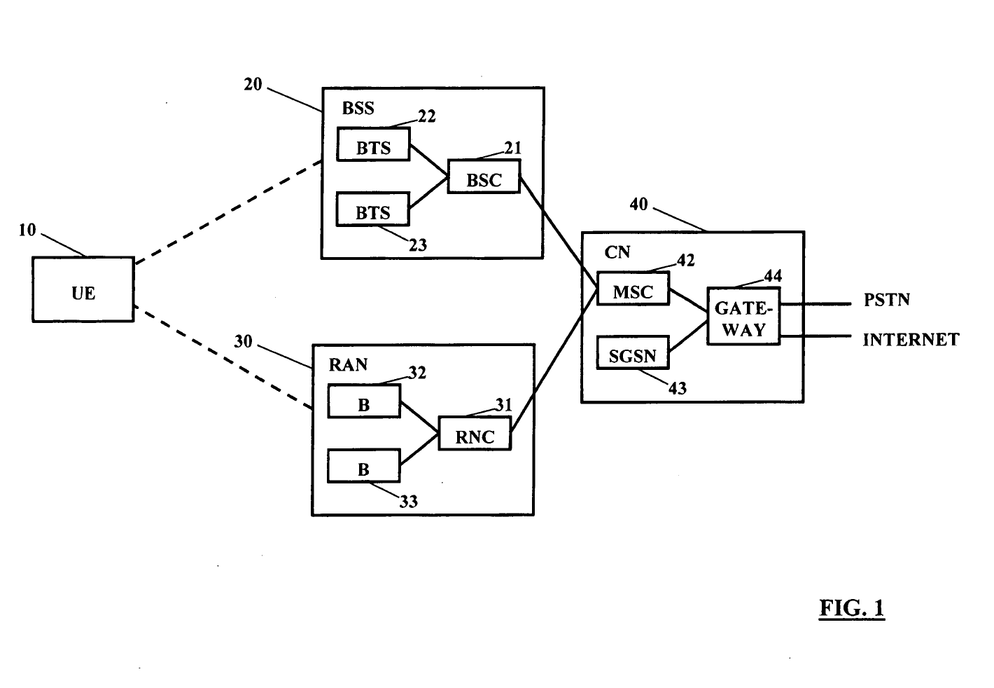

Referring to FIG. 1, a simplified structure of a communication network, such as a GSM or UMTS wireless network, is shown in which an embodiment of the present invention is applicable. It is to be noted that the network according to FIG. 1 represents only a simplified architecture of such a system in which the present invention is implemented. The network elements and/or their functions described herein may be implemented by software or by hardware. In any case, for executing their respective functions, correspondingly used devices or network elements comprise several means (not shown in FIG. 1) which are required for control, processing and communication functionality. Such means may comprise, for example, a processor unit for executing instructions and processing data, memory means for storing instructions and data, for serving as a work area of the processor and the like (e.g. ROM, RAM, EEPROM, and the like), input means for inputting data and instructions by software (e.g. floppy disc, CD-ROM, EEPROM, and the like), user interface means for providing monitor and manipulation possibilities to a user (e.g. a screen, a keyboard and the like), and interface means for establishing a communication connection under the control of the processor unit (e.g. wired and wireless interface means, an antenna, and the like).

In to FIG. 1, the major parts of a communication network in the form of a radio system are shown. The main parts of a radio system are a core network (CN) 40, an access network subsystem 20, 30 and a user equipment 10, such as a mobile station or the like. The access network subsystem 20, 30 may be implemented by wideband code division multiple access (WCDMA) technology. It may comprise a circuit switched component BSS (base station subsystem) 20 including at least one base station controller (BSC) 21 and one or more base transceiver stations (BTS) 22, 23, and a packet switched component RAN (radio access network) 30 including at least one radio network controller (RNC) 31 and one or more transceiver stations called node B (B) 32, 33. The detailed structure and functions of these and other network elements not shown in FIG. 1 are not described in greater detail, because they are generally known. In the following, an example of the present embodiment is described in connection with the BSS 20.

In the BSS 20, the BSC 21 controls the base transceiver station(s) 22, 23. For example, devices implementing the radio path and their functions reside in the BTSs 22, 23, and control devices reside in the BSC 21. The BSC 21 takes care of the following tasks, for instance: radio resource management of the BTS connected thereto, intercell handovers, frequency control, i.e. frequency allocation to the BTS 22, 23, management of frequency hopping sequences, time delay measurement on the uplink, implementation of the operation and maintenance interface, and power control. It is to be noted that the improved power control mechanism according to the present invention is preferably implemented in the BSC 21 (or similarly in the RNC 31).

The BTS 22, 23 include at least one transceiver, which provides one carrier, for example eight time slots, i.e. eight physical channels. Typically, one BTS serves one cell, but it is also possible that it serves several sectored cells. The tasks of the BTS 22, 23 include, for example, a calculation of timing advance (TA), uplink measurements, channel coding, encryption, decryption, and frequency hopping.

The user equipment 10, which may be a mobile station or the like, comprises at least one transceiver for establishing a radio link, for example, to the BSS 20. The user equipment 10 may comprise different subscriber identity modules. In addition, the user equipment 10 comprises an antenna (not shown), a user interface and a battery. As mentioned above, there are several different types of user equipments, for instance equipment installed in cars and portable equipment.

In the CN 40, a mobile services switching centre (MSC) 42 is a mobile network element that can be used to serve the connections of both the RAN 30 and the BSS 20. The tasks of the MSC 42 include, for example, switching, paging, user terminal location registration, handover management, collection of subscriber billing information, encryption parameter management, frequency allocation management, and echo cancellation. The number of MSCs may vary in dependence on the size of the respective network.

Similar to the MSC 42, a serving GPRS support node (SGSN) 43 is the centre point of the packet-switched side of the core network 40. The main task of the SGSN 43 is to transmit and receive packets with mobile stations supporting packet-switched transmission by using the base station subsystem 20 or the RAN 30. The SGSN 43 may comprise subscriber and location information related to the user equipment 10.

In addition, a gateway network element 44 is provided in the CN 40. Such gateway elements may comprise gateway mobile services switching centre (GMSC) and/or a gateway GPRS support node (GGSN), which takes care of circuit-switched and packet-switched connections between the core network 40 and external networks, such as a public switched telephone network (PSTN) or the Internet.

Even not shown explicitly in FIG. 1, there are defined plural interfaces between the network elements of the communication network. These interfaces provide specified connections between the elements and define what kind of messages different network elements can use in communicating with each other, and since they are known to those skilled in the art a detailed description thereof is omitted herein.

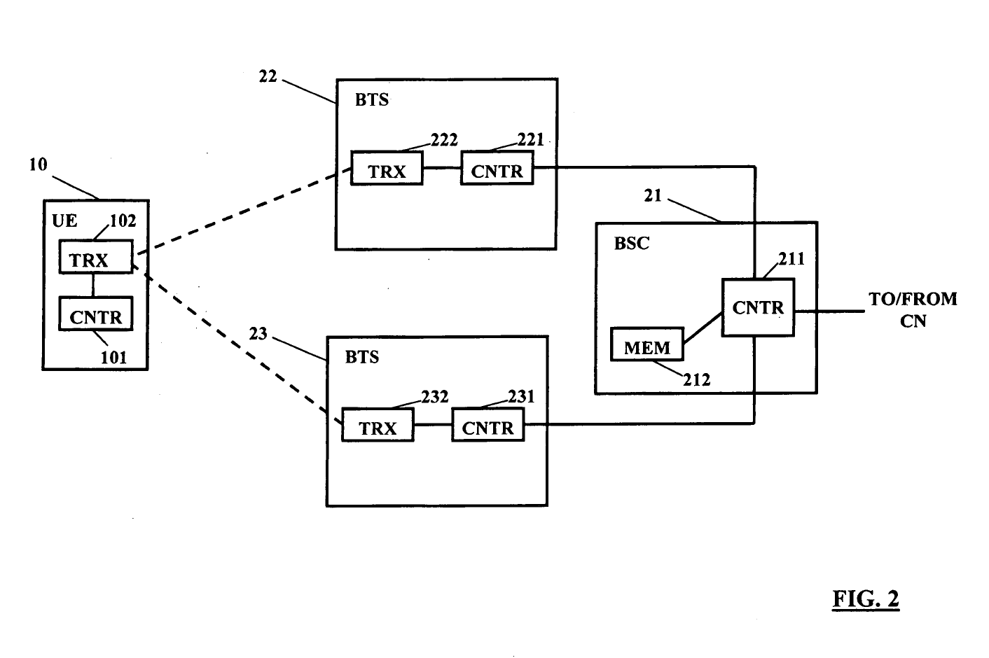

In FIG. 2, an illustration of the network elements of FIG. 1, which are involved in the power control mechanism according to an embodiment of the present invention, is shown in greater detail. The first BTS 22 comprises a transceiver (TRX) 222, a processing unit or control element 221 and an antenna (not shown). Similarly, the BTS 23 comprises a transceiver 232, a processing unit or control element 231 and an antenna (not shown). The BSC 21 also comprises a processing unit or control element 211 and a memory 212 in which data such as instructions and data tables or the like used by the control element 211 can be stored. The control elements 221 and 231 of the BTS 22, 23 are connected with the control element 211 of the BSC via a specified interface (not shown). The user equipment 10 also comprises a transceiver 102 and an antenna (not shown) for establishing a radio link to the (serving) BTS (for example BTTS 22), as indicated by dashed lines, and comprises a processing element 101. The transceivers 102, 222 and 232 may use TDMA technology, and for instance a normal GSM system GMSK (Gaussian Minimum Shift Keying) modulation or EDGE modulation, i.e. 8-PSK (8 Phase Shift Keying) modulation. The antennas can be implemented by normal prior art, for instance as omni directional antennas or antennas using a directional antenna beam.

It is to be noted that the processing elements 101, 211, 221, 232 refer to blocks controlling the operation of the device, which today are usually implemented using a processor with software, but different hardware implementations are also possible, such as a circuit made of separate logic components or one or more application-specific integrated circuits (ASIC). A combination of these methods is also possible.

In communications established via a communication network as shown in FIGS. 1 and 2, independent uplink and downlink channels are set up. The downlink carries transmissions from the network to multiple user terminals, and the uplink is shared among multiple user terminals for transmissions in which the user terminal transmits and the base transceiver station receives.

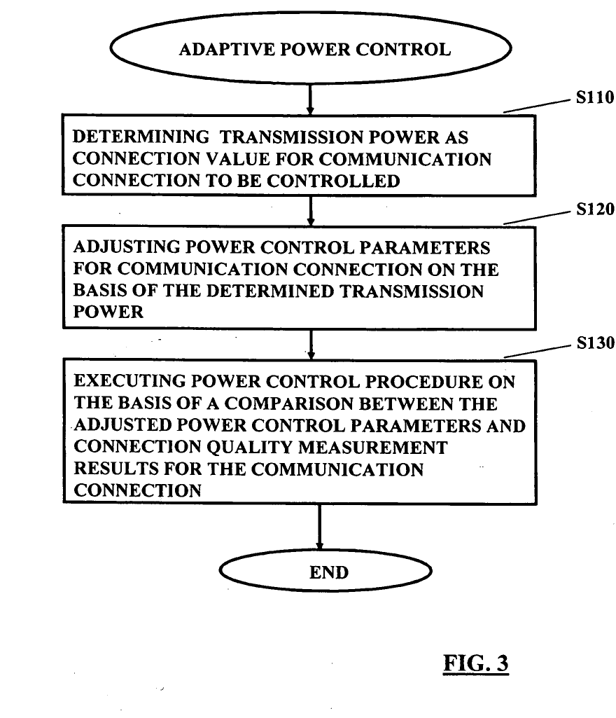

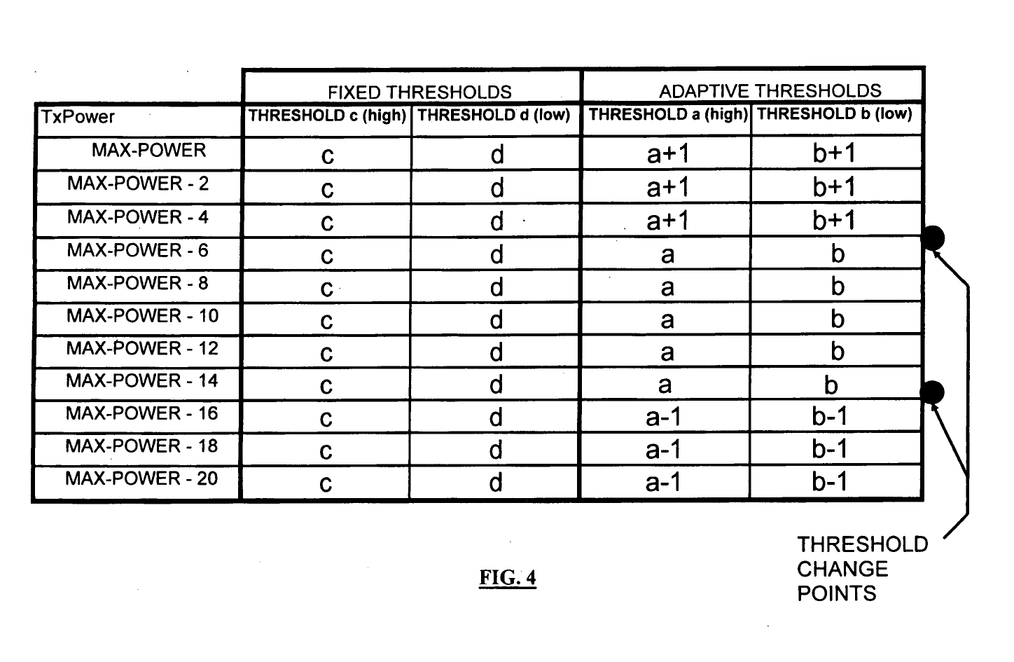

In the following, the power control according to an embodiment of the present invention is described in connection with the flow chart of FIG. 3 and a table of power control parameters as shown in FIG. 4.

First, an example of a communication connection for which the power control according to the embodiment is to be executed is described. In the structure shown in FIG. 2, it is assumed that the BTS 22 is a serving base station of the user equipment 10. A data transmission, such as a speech transmission, to and from the base station subsystem 20 to the user equipment 10 is performed via the serving base station 22. However, there may be one or more interfering base stations, for example the second base station 23, that cause interference to the downlink transmission. Furthermore, it is assumed that for the traffic channel an AMR codec is used, as mentioned above.

According to FIG. 3, when the power control method is started, in step S110 a connection value of the communication connection to be controlled is determined. This connection value is preferably the transmission power (Tx power) currently used for the transmission on the several channels, like the control channels and the traffic channels, but also other network measurements and/or network quality measurements can be used for this purpose, such as Timing Advance (TA), RX (received) level measurement (for evaluating a distance between the user equipment and the transceiver station), number of hopping frequencies (hopping gain depends on the number of hopping frequencies, and power control parameters or thresholds can be adjusted on the basis of a hopping performance) and the like.

Then, in step S120, power control parameters are adjusted on the basis of the determined connection value. The power control parameters are, for example, thresholds which are used for evaluating the connection quality on the basis of specific measurements. As an explanatory example, RXQUAL thresholds can be used as such thresholds, and the adjustment thereof is based on the actually used Tx power. Other examples could be, for example, RXLEV thresholds, thresholds for a bit error probability, for a frame error rate and the like. The selection of the type of threshold to be adjusted may be operator specific and/or dependent on the network structure and the signal/connection quality measures achievable. In other words, when the determined Tx power has a first value, the corresponding thresholds as the power control parameters are set to a first set of parameter values, while in case the determined Tx power has a second value, the corresponding thresholds as the power control parameters are set to a second set of parameter values. By means of this, different power control parameters can be set for different Tx power values or value ranges, so that, for example change points in a power control parameter table are defined. This will be described below in greater detail.

After the power control parameters, like the selected thresholds, are adjusted, the power control according to the present embodiment is executed in step S130, for example by comparing the thresholds with connection quality measurement results received from the network, such as actual RXQUAL or RXLEV values, bit rate or frame error measurements and the like for the communication connection between the user equipment 10 and the BTS 22. If the comparison shows that the actual detected connection quality measurement does not match with the adjusted thresholds, the transmission power of the respective transceivers, such as the transceivers 102 or 222, is controlled to be decreased or increased, in dependence on the determined difference between the thresholds and the actual measurement value. The transmission power change is sent as an control instruction to the corresponding network element, i.e. to the user equipment 10 (uplink) and/or to the BTS 22 (downlink) where the transmission power is correspondingly changed. Thereafter, the power control procedure is ended. It is to be noted that this power control can be executed repeatedly, for example in predefined intervals.

In the network structure shown in FIG. 2, the power control procedure described above is executed in the control element 211 of the BSC 21. Additionally or alternatively thereto, the power control procedure is executed in a corresponding control element (not shown) of the radio network controller 31. As another option, the element, i.e. the controller executing the power control can be comprised in a transceiver station, for example the base transceiver station or the like, of the communication network. Data tables indicating the respective power control parameters and change points can be stored, for example, in the memory 212 of the BSC 21 (or a corresponding memory (not shown) of the RNC 31 or a transceiver station). On the other hand, measurement and determination results may be achieved from other network elements, such as the user equipment 10, the BTSs 22 and 23, and the nodes B 32 and 33. The sensing of the measurement result can be performed by devices and methods known for those skilled in the art. It is to be noted that the execution of the power control method described above is not limited to the BSC 21 but can be executed also in other network elements, such as a MSC, as long as the necessary data are available at this network element and the instructed changes in the transmission power can be transmitted to the respective transceivers.

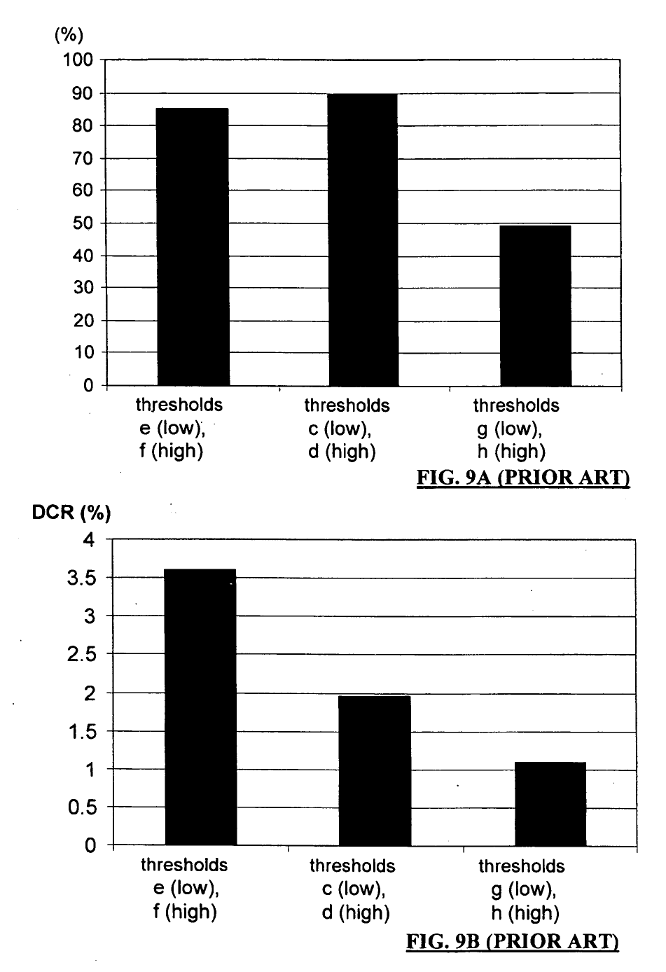

In FIG. 4, a data table is shown in which different power control parameters for a connection value are listed. In the left column, several transmission power values starting with a maximum power and decreased in steps of 2 (the step size shown in FIG. 4 is only an example and can be varied in different applications) are listed which represent the connection value determined. In the second and third columns, power control parameters according to a conventional power control are listed. In detail, the second column defines high level thresholds and the third column defines low level thresholds, such as, for example RXQUAL, RXLEV threshold and the like. As mentioned above, in the conventional power control, the power control values based on the thresholds are fixed values and the same for all transmission power levels, representing a trade-off between voice quality and system capacity, as also shown in FIGS. 9a, 9b. On the other hand, adaptive power control parameters such as correspondingly selected thresholds are adjusted in accordance with the power control mechanism according to the present embodiment. These adaptive power control parameters are indicated in the fourth and fifth column in FIG. 4. As can be seen, in the present example, between the Tx power levels max-power −4 and max-power −6 as well as max-power −14 and max-power −16 the power control parameters (thresholds) are changed (i.e. at corresponding thresholds change points). It is to be noted that there can be defined also less or more changes of the power control parameters (i.e. more or less than two change points). The actual number of changes may depend, for example, on the network structure, operator settings or network capabilities. When the determined transmission power lies within one of the ranges defined by the change points, the corresponding threshold is selected, i.e. the power control parameter is adjusted. However, when the transmission power is changed to another range, the power control parameter is also changed which in turn influences the power control behavior when the connection quality measurement is evaluated in the power control procedure. In other words, in the presented explanatory example according to this embodiment, the basic thresholds are: a as a low power control parameter threshold and b as a high power control parameter threshold (e.g. RXQUAL 4 for a and RXQUAL for b). If the used Tx power is closer than 4 (e.g. dBm) compared to the maximum Tx power both thresholds a and b are increased by one (a+1, b+1), and when the Tx power is more than 14 (e.g. dBm) lower compared to the maximum Tx power, both thresholds a and b are reduced by one (a-1, b-1). It is to be noted that the value for increasing and decreasing the thresholds is not limited to +/−1, and it is also possible to change only one of the thresholds a or b.

Data tables like that shown in FIG. 4 (i.e. forth and fifth column in connection with first column) comprising one or more changes of the power control parameters (i.e. change points) can be acquired on the basis of tests or simulations and stored in the memory 212 of the BSC 21 beforehand. Alternatively, the settings of the data tables indicating the power control parameters can also be calculated on the basis of stored programs or formulas usable for calculating the values with respect to environmental parameters or the like so that a more flexible power control is achievable.

Preferably, the power control using the adaptive power control parameters according to the present embodiment is used for traffic channel, such as a traffic channel using AMR.

In other words, when looking at an GSM/EDGE communication network, according to the embodiment described above, traffic channel power is controlled such that the SACCH receives less interference. This is achieved by a power control for the AMR using traffic channel which is optimized for AMR itself, so that a total interference in the system can be reduced. As mentioned above, the power control algorithm generally has to maintain the signal level high enough to ensure good voice quality for the served connection. On the other hand, power control needs to keep the Tx power as low as possible in order to maintain low interference in the network. Furthermore, in case of using AMR speech service, the power needs to be reduced so that also SACCH performance is ensured in the system. Hence, according to the present embodiment, adaptive parameters are used in the power control algorithm. Power control parameters, for example selected thresholds like RXQUAL thresholds, are adapted based on used Tx power level and also based on network quality measurements.

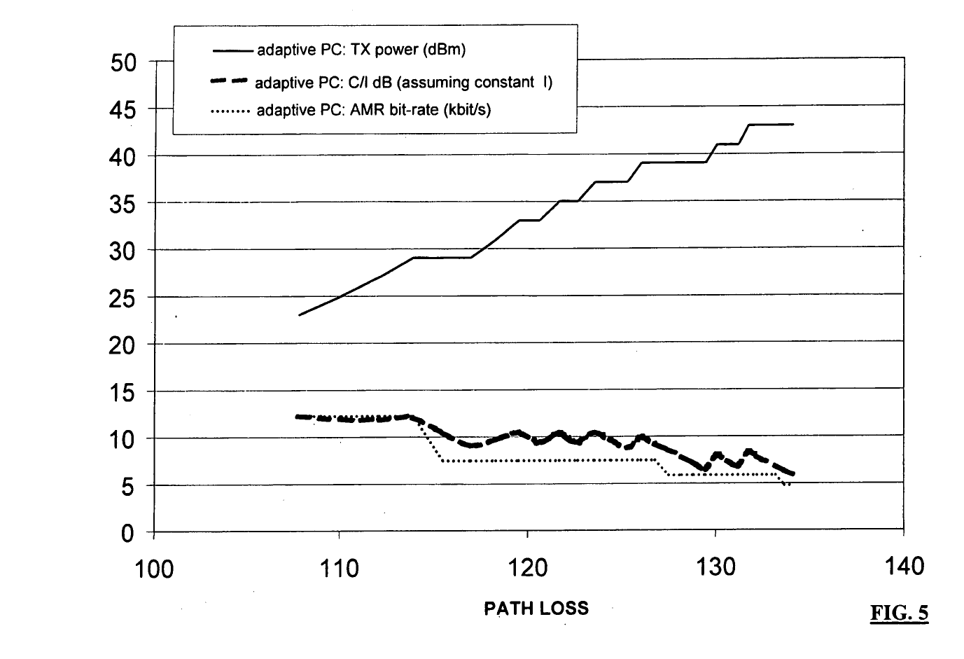

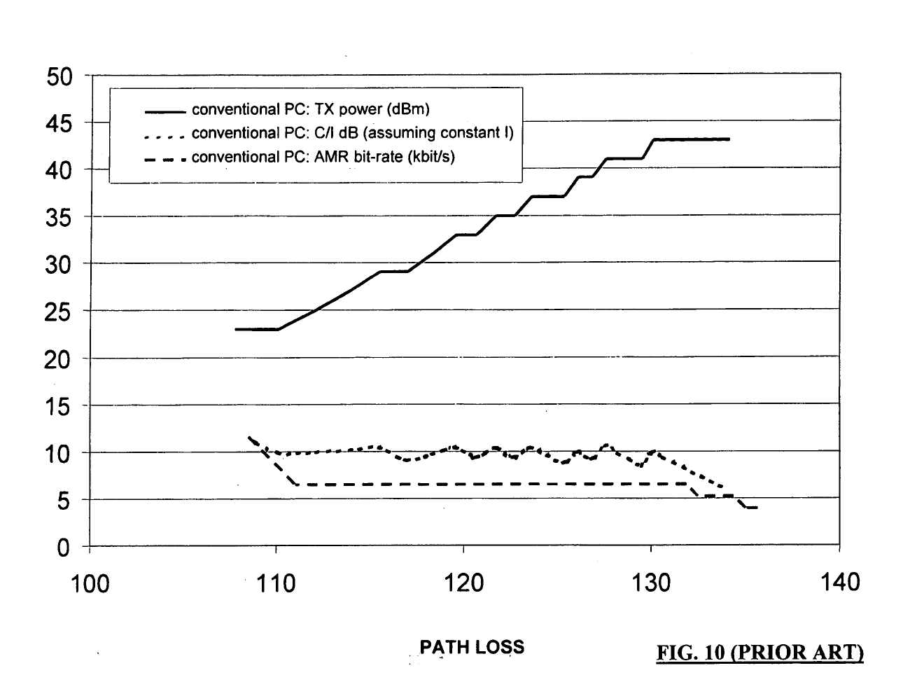

In the following, the results of an adaptive power control according to the present embodiment in comparison to a conventional example using fixed power control parameters are illustrated in connection with FIGS. 5 to 8 and 10. In FIG. 5, three curves representing results of the power control according to the present invention are shown. On the other hand, for evaluating the results of the present embodiment, FIG. 10 shows a similar diagram where the power control parameters according to the conventional example are used. In both FIGS. 5 and 10, the abscissa represents a path loss from the base transceiver station (e.g. BTS 22) to the user equipment (e.g. UE 10), the ordinate represents comparative values for the respective curves shown in the diagrams, the solid curve shows the Tx power levels which are set by the power control executed on the basis of the respective thresholds (fixed or adjusted), the dotted curve shows a carrier-to-interference ratio (C/I) where it is assumed that the interference level remains constant, and the dashed line shows an achieved bit rate of an AMR speech channel.

When comparing the curves of FIGS. 5 and 10, it can be seen how the present embodiment employing the adaptive PC and the CMA works together in order to improve the network capacity while maintaining a high voice quality at the same time. At the left end of the respective curves, it can be seen that the adaptive power control according to the present embodiment uses higher powers so that high bit rates are used when there is a low path loss/interference (i.e. the AMR speech quality is maximized). On the other side, at the right end of the curves, it can be seen that the adaptive power control minimizes the usage of high transmission powers so that low bit rates are used when there is a high path loss/interference (i.e. the AMR system capacity is maximized). This means that in the embodiment of the present invention high bit-rate AMR modes are used when this does not cause an undue interference to other connections. However, when the used Tx power is close to the maximum power, the power control parameters (thresholds) are tightened so that high Tx powers are used only in very few cases, when that is the only way to provide a sufficient voice quality. By making the power control adjusting the transmission power this way, the CMA is able to adapt to the situation so that more robust modes are used when higher Tx powers are used. As shown in FIG. 5, different AMR bit-rates are used more efficiently in case of adaptive PC.

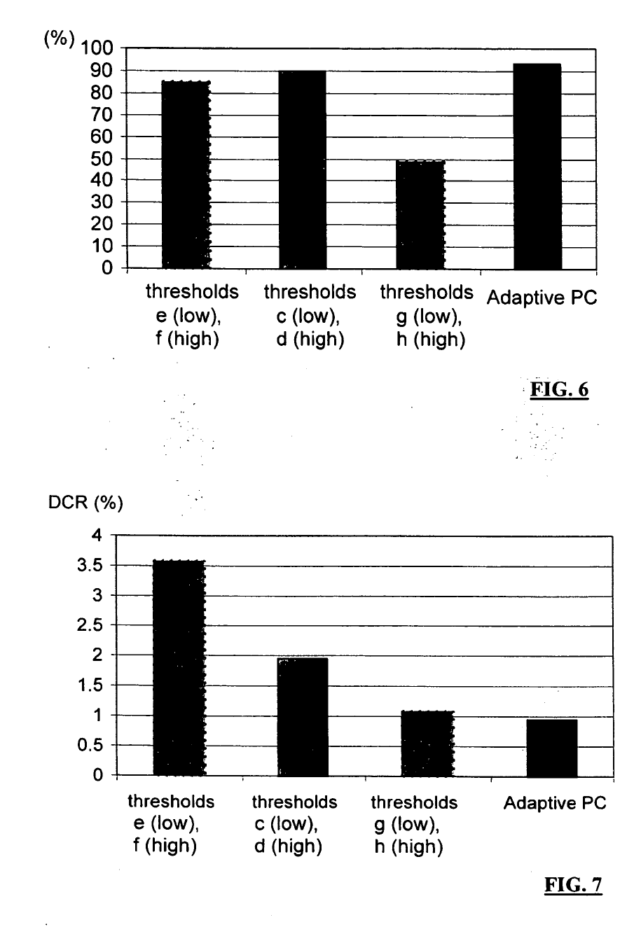

In FIGS. 6 to 8, for illustrating the effects of an adaptive power control as described above, further comparisons of results achieved by a power control according to the present embodiment, i.e. the adaptive power control, and a conventional power control are depicted. It is to be noted that the scale of the respective axes and hence the levels reached by the bars in FIGS. 6 to 8 are only for illustration. Actual levels or values may be different to those shown in these figures. The fixed settings for thresholds in FIGS. 6 and 7, i.e. threshold values e/f, c/d and g/h are increased from left to right. The rightmost bar shows results achieved by using adaptive power control parameters, like adjusted thresholds, based on the connection value, such as the transmission power used. Only as an explanatory example, when RXQUAL thresholds are used as power control parameters, values like low 3 and high 4 for e/f, low 4 and high 5 for c/d, and low 5 and high 6 for g/h can be used, for example.

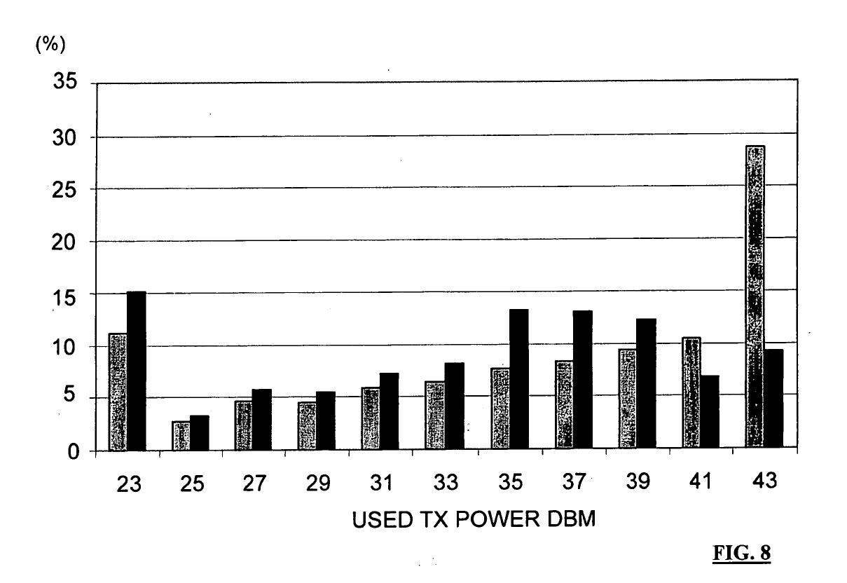

In FIG. 6, similar to FIG. 9a, a percentage value of good quality connections for different fixed thresholds (grey bars) and adaptive thresholds (black bar) as power control parameters are shown. Again, a good quality connection means in the present example a connection where the traffic channel FER is smaller than 1%. In FIG. 7, similar to FIG. 9b, the drop call rate based on the SACCH RLT for the same thresholds as in FIG. 6 (grey bars: conventional PC; black bar: adaptive power control) is shown. In FIG. 8, a comparison of used transmission power levels after performing the power control according to the present embodiment of the adaptive power control (black bar) and the conventional power control (grey bars) is depicted. As can be seen from these results, by using the adaptive power control of the present embodiment, i.e. the adaptive PC thresholds, the AMR voice quality increased while at the same time the number of dropped calls (based on SACCH RLT) is significantly decreased, in comparison to the conventional power control. Furthermore, as shown in FIG. 8, the usage of the adaptive power control decreases the number of settings of the maximum Tx power level.

As mentioned above, the BSS is configured to adapt AMR PC thresholds based on currently used Tx power (other network measurements can also be used). Thresholds are tightened when higher Tx powers are used. In this way, the usage of high Tx powers is reduced and system interference becomes lower, which in turn improves the SACCH performance. On the other hand, when low Tx powers are in use, PC thresholds are loosened so that the signal quality can be maintained on a high level and a good speech quality can be offered to the connection in the cases when not too much interferences to other connections in the network are caused. Hence, the proposed adaptive power control mechanism optimizes AMR voice quality and capacity, and balances the performance difference between AMR speech and SACCH.

In the embodiment described above, the adjustment of the power control parameter concerns in particular the setting of selected thresholds, such as an RXQUAL threshold, RXLEV threshold and the like. However, according to the present invention, also a power increase/decrease step size can be adjusted in connection with the adaptive power control procedure. The power increase and decrease step size is used to change the transmission power with a predetermined rate. In the conventional power control, the increase step size and the decrease step size are fixed, for example to a 2 dB increase step size and a 1 dB decrease step size.

In the adaptive power control procedure according to the present invention, the power increase/decrease step size can be made adjustable so that, for example, power is increased faster when the connection value has a first level, e.g. when the Tx power is low. This is beneficial in situations where a communication connection has, for example, first very good signal, e.g. in a line of sight situation, and therefore minimum Tx power is in use. When the user moves behind a corner or the like, the signal level may decrease very fast. On the other hand, when the user is located closer to a cell border these kind of fast changes in signal levels are much more rarely (e.g. a not line of sight case). Therefore, a greater power change step size is beneficial to be used when the connection value has a second level, e.g. when a low Tx power is used, while smaller power increases with already high Tx powers maintains the network interference lower.

Furthermore, the adaptive power control described above can be further improved by means of transmitting bursts on the control channel with a greater transmission power than the data on the traffic channel. In particular, when transmitting SACCH bursts with the maximum transmission power all the time while the AMR speech service transmission power is adjusted as described in the preceding embodiments, the SACCH performance can be further improved compared to AMR speech which now uses the maximum Tx power much more rarely, as depicted for example in FIG. 8.

Even though the above described embodiments are mainly directed to GSM/EDGE systems, and more precisely to an AMR speech service power control algorithm, it is to be noted that the present invention is not limited to such an application. The power control mechanism described above can also be used in connection with other communication system types as long as there is a power control for a transmission power to be executed.

As described above, a method of controlling a transmission power for a communication connection in a communication network is provided. The communication network comprises a user equipment communicating with the communication network, at least one transceiver station for providing a connection with the user equipment, wherein a serving transceiver station is provided for the user equipment, and a controller for controlling the at least one transceiver station. A connection value used at the communication connection between the user equipment and the serving transceiver station is determined, and on the basis of the determined connection value, power control parameters are adjusted wherein at least one change of power control parameters is possible between respective connection value ranges. A power control of the transmission power for the communication connection is executed on the basis of a comparison between the adjusted power control parameters and connection quality measurement results determined for the communication connection. Furthermore, a corresponding system and a corresponding controller are provided.

It should be understood that the above description and accompanying figures are merely intended to illustrate the present invention by way of example only. The preferred embodiments of the present invention may thus vary within the scope of the attached claims.

1. A method of controlling a transmission power for a communication connection in a communication network, the method comprising:
providing a user equipment communicating with the communication network;
providing at least one transceiver station for providing a connection with the user equipment, wherein a serving transceiver station is provided for the user equipment;
providing a controller for controlling the at least one transceiver station;
determining a connection value used at the communication connection between the user equipment and the serving transceiver station;
adjusting power control parameters on the basis of the determined connection value; and
executing a power control of the transmission power for the communication connection on the basis of a comparison between the adjusted power control parameters and connection quality measurement results determined for the communication connection.

2. The method according to claim 1, wherein in the step of adjusting the power control parameters at least one change of power control parameters is possible between respective connection value ranges.

3. The method according to claim 1, wherein the step of determining a connection value comprises a step of determining a transmission power level of the communication connection.

4. The method according to claim 3, wherein the step of determining a transmission power level comprises a determination of a transmission power level of at least one of the user equipment and the serving transceiver station.

5. The method according to claim 1, wherein the step of determining a connection value comprises a step of determining a result of a network quality measurement result.

6. The method according to claim 1, wherein the step of determining a connection value comprises a step of determining a distance between the user equipment and the transceiver station.

7. The method according to claim 1, wherein the step of determining a connection value comprises a step of determining at least one of a received signal level from the user equipment to the transceiver station and a received signal level from the transceiver station to the user equipment.

8. The method according to claim 1, wherein the power control parameters comprises a threshold value of a connection quality measurement, in particular of at least one of a bit error rate measurement and a frame error rate measurement.

9. The method according to claim 1, wherein the step of adjusting the power control parameters further comprises a step of setting a changing step size for changing the transmission power.

10. The method according to claim 1, wherein the step of adjusting the power control parameters comprises a step of increasing the power control parameters when the determined connection value is high.

11. The method according to claim 9, wherein the step of adjusting the power control parameters comprises a step of increasing the changing step size of the transmission power when the determined connection value is low.

12. The method according to claim 1, wherein the step of executing the power control of the transmission power for the communication connection on the basis of the adjusted power control parameters is performed for a traffic channel of the communication connection.

13. The method according to claim 12, further comprising a step of setting the transmission power for a control channel to a higher value than the transmission power used for the traffic channel.

14. The method according to claim 12, further comprising a step of using an adaptive multi-rate speech service for the traffic channel, wherein a codec mode adaptation is executed for the adaptive multi-rate speech service.

15. The method according to claim 1, wherein the step of executing the power control of the transmission power for the communication connection on the basis of the adjusted power control parameters is performed in an uplink direction and in a downlink direction.

16. The method according to claim 1, wherein the communication network is a radio communication network, the user equipment is a mobile user terminal, the transceiver station is a base station of the radio communication network and the controller is comprised in a base station controller or a radio network controller of the radio communication network.

17. A system for controlling a transmission power for a communication connection of a user equipment communicating in a communication network, the system comprising:
at least one transceiver station for providing a connection with the user equipment, wherein a serving transceiver station is provided for the user equipment; and
a controller for controlling the at least one transceiver station,
wherein the system is operably connected and configured to
determine a connection value used at the communication connection between the user equipment and the serving transceiver station,
adjust power control parameters on the basis of the determined connection value, and
execute a power control of the transmission power for the communication connection on the basis of a comparison between the adjusted power control parameters and connection quality measurement results determined for the communication connection.

18. The system according to claim 17, wherein the system is configured to adjust the power control parameters by means of at least one change of power control parameters between respective connection value ranges.

19. The system according to claim 17, wherein the system is configured to determine, as the connection value, a transmission power level of the communication connection.

20. The system according to claim 19, wherein the system is configured to determine the transmission power level by determining the transmission power level of at least one of the user equipment and the serving transceiver station.

21. The system according to claim 17, wherein the system is configured to determine a result of a network quality measurement result for determining the connection value.

22. The system according to claim 17, wherein the system is configured to determine a distance between the user equipment and the transceiver station for determining the connection value.

23. The system according to claim 17, wherein the system is configured to determine at least one of a received signal level from the user equipment to the transceiver station and a received signal level from the transceiver station to the user equipment for determining the connection value.

24. The system according to claim 17, wherein the power control parameters comprises a threshold value of a connection quality measurement, in particular of at least one of a bit error rate measurement and a frame error rate measurement.

25. The system according to claim 17, wherein the system is further configured to set a changing step size for changing the transmission power on the basis of the determined connection value.

26. The system according to claim 17, wherein the system is further configured to increase the power control parameters when the determined connection value is high.

27. The system according to claim 25, wherein the system is configured to increase the changing step size of the transmission power when the determined connection value is low.

28. The system according to claim 17, wherein the system is configured to execute the power control of the transmission power for the communication connection on the basis of the adjusted power control parameters for a traffic channel of the communication connection.

29. The system according to claim 28, wherein the system is configured to set the transmission power for a control channel to a higher value than the transmission power used for the traffic channel.

30. The system according to claim 28, wherein the communication network is configured to use an adaptive multi-rate speech service for the traffic channel, wherein a codec mode adaptation is executed for the adaptive multi-rate speech service.

31. The system according to claim 17, wherein the system is configured to execute the power control of the transmission power for the communication connection on the basis of the adjusted power control parameters in an uplink direction and in a downlink direction.

32. The system according to claim 17, wherein the communication network is a radio communication network, the user equipment is a mobile user terminal, the transceiver station is a base station of the radio communication network and the controller is comprised in a base station controller or a radio network controller of the radio communication network.

33. A controller for controlling a transmission power for a communication connection of a user equipment communicating in a communication network, the communication network comprising at least one transceiver station for providing a connection with the user equipment, wherein a serving transceiver station is provided for the user equipment, wherein the controller is configured to control the at least one transceiver station and is further operably connected and configured to:
determine a connection value used at the communication connection between the user equipment and the serving transceiver station;
adjust power control parameters on the basis of the determined connection value; and
execute a power control of the transmission power for the communication connection on the basis of a comparison between the adjusted power control parameters and connection quality measurement results determined for the communication connection.

34. The controller according to claim 33, wherein the controller is configured to adjust the power control parameters by means of at least one change of power control parameters between respective connection values ranges.

35. The controller according to claim 33, wherein the controller is configured to receive and determine, as the connection value, a transmission power level of the communication connection.

36. The controller according to claim 35, wherein the controller is configured to receive and determine the transmission power of at least one of the user equipment and the serving transceiver station.

37. The controller according to claim 33, wherein the controller is configured to receive and determine a result of a network quality measurement result for determining the connection value.

38. The controller according to claim 33, wherein the controller is configured to receive and determine a result of a determination of a distance between the user equipment and the transceiver station for determining the connection value.

39. The controller according to claim 33, wherein the controller is configured to determine and receive at least one of a received signal level from the user equipment to the transceiver station and a received signal level from the transceiver station to the user equipment for determining the connection value.

40. The controller according to claim 33, wherein the power control parameters comprises a threshold value of a connection quality measurement, in particular of at least one of a bit error rate measurement and a frame error rate measurement.

41. The controller according to claim 33, wherein the controller is further configured to set a changing step size for changing the transmission power on the basis of the determined connection value.

42. The controller according to claim 33, wherein the controller is further configured to increase the power control parameters when the determined connection value is high.

43. The controller according to claim 41, wherein the controller is configured to increase the changing step size of the transmission power when the determined connection value is low.

44. The controller according to claim 33, wherein the controller is configured to execute the power control of the transmission power for the communication connection on the basis of the adjusted power control parameters for a traffic channel of the communication connection.

45. The controller according to claim 44, wherein the controller is configured to set the transmission power for a control channel to a higher value than the transmission power used for the traffic channel.

46. The controller according to claim 44, wherein the communication network is configured to use an adaptive multi-rate speech service for the traffic channel, wherein a codec mode adaptation is executed for the adaptive multi-rate speech service.

47. The controller according to claim 33, wherein the controller is configured to execute the power control of the transmission power for the communication connection on the basis of the adjusted power control parameters in an uplink direction and in a downlink direction.

48. The controller according to claim 33, wherein the controller is comprised in a base station controller of a circuit switched radio communication network for controlling a base station as a transceiver station communicating with a user terminal.

49. The controller according to claim 33, wherein the controller is comprised in a radio network controller of a packet switched radio communication network for controlling a transceiver station communicating with a user terminal.

50. The controller according to claim 33, wherein the controller is comprised in a transceiver station of a radio communication network.
